(19) United States
(12) Patent Application Publication
(10) Pub. No.: US 2003/0192635 A1
(43) Pub. Date: Oct. 16, 2003

(54) Tire steel cord having improved adhesiveness and corrosion resistance

(76) Inventors: Young Jim Kim, Ulsan-Shi (KR); Min An Kim, Ulsan-Shi (KR); Bong Young Sohn, Gwangju-Shi (KR)

Correspondence Address: Y. ROCKY TSAO, Fish & Richardson P.C., 225 Franklin Street, Boston, MA, 02110-2804, US

(21) Appl. No.: 10/319,186

(22) Filed: Dec. 13, 2002

(30) Foreign Application Priority Data
Apr. 10, 2002 (KR) 2002-19506

(51) Int. Cl. B60C 9/00; B32B 15/02; D07B 1/06

(52) U.S. Cl. 152/451; 152/565; 428/380; 428/379; 428/389

(57) ABSTRACT

A tire steel cord which is produced by coating the surface of a brass-plated steel cord with a compound selected from the group consisting of 2-amino-4,6-dimethoxy pyrimidine, 3,5-dimethoxybenzoic acid and m-anisic acid, is disclosed. The tire steel cord has excellent initial and aged adhesion to rubber, improved rubber coverage and controlled oxidation rate on its surface.

### BACKGROUND OF THE INVENTION

Priority Korean Patent Application No. 2002-19506 filed Apr. 10, 2002 is incorporated herein in its entirety by reference.

1. Field of the Invention

The present invention relates to a tire steel cord which is produced by coating the surface of a brass-plated steel cord with a coating compound capable of improving the adhesion between the brass-plated steel cord and rubber and the corrosion resistance of the tire steel cord. The tire steel cord has excellent initial and aged adhesion to rubber and corrosion resistance.

2. Description of the Related Art

For sustaining the heavy weight of vehicles and stabilizing steering at high-speeds, a brass-plated steel cord has been used in the belt and carcass of a tire. Generally, the brass-plated steel cord used as a reinforcing element of tire is produced by thinly coating the surface of a steel cord with brass having a copper (Cu) and zinc (Zn) weight ratio of 62:38-70:30 to facilitate and enhance the adhesion of the steel cord to rubber. However, moisture and oxygen on the surface of the brass-plated steel cord react with brass to form a layer of ZnO or Zn(OH)₂. These layers interfere the adhesion between rubber and the brass-plated steel cord, thereby decreasing the service life of the tire. Korean Patent No. 66094 discloses a technique comprising applying paranitroaniline on the surface of a brass-plated steel cord. However, paranitroaniline is harmful to the human body and therefore the technique is limited in its practical use. Recently, a technique using silane (U.S. Pat. No. 6,261,638) and a technique using plasma discharge (U.S. Pat. No. 5,783,641) were developed. However, any techniques heretofore developed are still unsatisfactory in improving the adhesion between the brass-plated steel cord and rubber. Further, U.S. Pat. No. 4,283,460 discloses a method for treating a brass-coated steel cord with either benzotriazole, cyclohexylamine borate, or a mixture thereof to treat a brass-coated steel cord. According to this method, an alcoholic solution of benzotriazole, cyclohexylamine borate or a mixture thereof is treated on the brass-coated steel cord. This method has an advantage of reducing surface contamination of the brass-coated steel cord. However, this method has problems in terms of poor initial and aged adhesion between the brass-coated steel cord and rubber.

### SUMMARY OF THE INVENTION

Therefore, the present invention has been made in view of the above-mentioned problems, and it is an object of the present invention to provide a tire steel cord which is produced by coating the surface of a brass-plated steel cord with a coating compound capable of improving the adhesion between the brass-plated steel cord and rubber and corrosion resistance of the tire steel cord, thereby reducing the amount of costly adhesion promoter used, and having aged adhesion to rubber and corrosion resistance.

In accordance with the present invention, there is provided a tire steel cord which is produced by coating the surface of a brass-plated steel cord with a compound selected from the group consisting of 2-amino-4,6-dimethoxy pyrimidine, 3,5-dimethoxybenzoic acid and m-anisic acid.

### DETAILED DESCRIPTION OF THE INVENTION

Hereinafter, the present invention will be explained in more detail.

In order to improve the adhesion between the steel cord and rubber, a compound selected from the group consisting of 2-amino-4,6-dimethoxy pyrimidine, 3,5-dimethoxybenzoic acid, and m-anisic acid is coated on the surface of the brass-plated steel cord.

Prior to coating the surface of the brass-plated steel cord with the coating compound, the coating compound is dissolved in one and more solvents selected from the group consisting of alcohol, ether, acetone, benzene and water, but the present invention is not particularly limited to these solvents. Herein, the concentration of the solution is preferably in the range of 0.1-40 mol %. When the concentration exceeds 40 mol %, the adhesion to the brass-plated steel cord and rubber coverage are reduced, and economic efficiency is unfavorable due to the excess amount of the coating compound.

The method for coating the surface of the brass-plated steel cord with the solution is not particularly limited. For example, the brass-plated steel cord may be dipped into the solution, and then dried. At this time, the brass-plated steel cords can be dipped separately or in the strand form.

Hereinafter, the present invention will now be described in more detail with reference to the following Examples. However, these examples are given for the purpose of illustration and not of limitation.

1. Preparation of test pieces

### EXAMPLE 1

Steel cords (2+2×0.25) which had been plated with brass consisting of 63.5% by weight of Cu and 36.5% by weight of Zn were dipped into solutions of 2-amino-4,6-dimethoxy pyrimidine in methanol at various concentrations (0.1 mol %, 0.5 mol %, 1 mol %, 10 mol % and 40 mol %), respectively, to coat the surface of the brass-plated steel cords. The coated brass-plated steel cords were dried in atmosphere and then stored in a desiccator before the adhesion test.

### EXAMPLE 2

Steel cords (2+2×0.25) which had been plated with brass consisting of 63.5% by weight of Cu and 36.5% by weight of Zn were dipped into solutions of 3,5-dimethoxy benzoic acid in methanol at various concentrations (0.1 mol %, 0.5 mol %, 1 mol %, 10 mol % and 40 mol %), respectively, to coat the surface of the brass-plated steel cords. The coated brass-plated steel cords were dried in atmosphere and then stored in a desiccator beforethe adhesion test.

### EXAMPLE 3

Steel cords (2+2×0.25) which had been plated with brass consisting of 63.5% by weight of Cu and 36.5% by weight of Zn were dipped into solutions of m-anisic acid in methanol at various concentrations (0.1 mol %, 0.5 mol %, 1 mol %, 10 mol % and 40 mol %), respectively, to coat the surface of the brass-plated steel cords. The coated brass-plated steel cords were dried in atmosphere and then stored in a desiccator before the adhesion test.

### Comparative Example

Untreated steel cords (2+2×0.25) which had been plated with brass consisting of 63.5% by weight of Cu and 36.5% by weight of Zn were stored in a desiccator before the adhesion test.

2. Adhesion Test

The test pieces prepared in Examples 1 to 3 and Comparative Example were adhered to rubber to prepare specimens for measuring their adhesions, in accordance with the procedure described in ASTM D 2229-85. The specimens thus prepared were vulcanized in a hot plate type vulcanization press at a temperature of 177° C. under a pressure of 25 kg/cm² for 12 minutes, and then left in atmosphere for 8 hours. The adhesion test on the specimens thus produced was performed using a tensile tester in accordance with ASTM 2229-79 method. Adhesion strength was determined as the force necessary to pull the tire steel cords out from molding rubber. The results are shown in Table 2. Further, rubber coverage was determined as a percentage of rubber-remaining area on the surface of the steel cords after pulling the tire steel cords out from molding rubber by naked eye. The results are shown in Table 3.

3. Corrosion Resistance Test

Three test pieces (coating solution concentration: 0.5 mol %) obtained in Examples 1 to 3 and the test piece obtained in Comparative Example were left under conditions of 95° C. and 95% RH, and then the degree of oxidation on the surface and occurrence of rust over time (1, 2, 6, 12, 24, 48 and 72 hours) were measured by naked eye.

TABLE 1
Rubber formulation

| Components | Amount used (PHR) ¹⁾ |
|---|---|
| Natural rubber ²⁾ | 100 |
| Carbon black ³⁾ | 55 |
| ZnO ⁴⁾ | 5 |
| Stearic acid | 1.0 |
| Antioxidant ⁵⁾ | 2.0 |
| Co complex ⁶⁾ | 0.16 |
| Resorcinol Resin ⁷⁾ | 2.0 |
| HMMM ⁸⁾ | 4.0 |
| Sulfur | 5.4 |
| Accelerator (DCBS) ⁹⁾ | 0.8 |
| Aromatic oil ¹⁰⁾ | 5.0 |

¹⁾ PHR: parts per hundred rubber
²⁾ SMR-20 (Product name, Mardec Co., Malaysia)
³⁾ N330 (Product name, Lucky Carbon, Korea)
⁴⁾ Hanil Chemical Co, Korea
⁵⁾ N-(1,3-dimethylbutyl)-N′-phenylenediamine (Kumho petrochemical Co., Ltd, Korea)
⁶⁾ 23% cobalt boroacylate salt (Rhone poulen, U.K)
⁷⁾ Resorcinol formaldehyde resin: B18-S(Product name, Inspec Co., USA)
⁸⁾ Hexa-methoxy-methyl-melamine (Cytec Co., USA)
⁹⁾ N-dicyclohexyl-2-benzotriazolsulfoneamide (Bayer Co., Belgium)
¹⁰⁾ Manufactured by Michang Oil Ind. Co., Ltd.

TABLE 2
Adhesion test

| | | | | Aged adhesion (kg/0.5″) | | | | |
|---|---|---|---|---|---|---|---|---|
| | | | | | Room | | High | |
| | | | | | temper- | | temper- | |
| | | | | | ature | | ature | |
| | | | | | high | | high | Saline |
| | | | Initial | over- | humidity | Heat | humidity | water |
| | | | adhesion | vulcan- | deteri- | deteri- | deteri- | deteri- |
| Examples | | | (kg/0.5″) | ization | oration | oration | oration | oration |
| Comp. | Un- | | 42 | 32 | 36 | 35 | 22 | 13 |
| Example | treated | | | | | | | |
| Example 1 | 0.1 | mol % | 47 | 36 | 40 | 41 | 25 | 15 |
| | 0.5 | mol % | 47 | 37 | 44 | 45 | 24 | 15 |
| | 1 | mol % | 49 | 42 | 43 | 46 | 28 | 18 |
| | 10 | mol % | 48 | 41 | 47 | 45 | 30 | 20 |
| | 40 | mol % | 40 | 35 | 35 | 34 | 23 | 14 |
| Example 2 | 0.1 | mol % | 44 | 37 | 42 | 39 | 23 | 18 |
| | 0.5 | mol % | 45 | 39 | 43 | 41 | 23 | 17 |
| | 1 | mol % | 50 | 39 | 47 | 44 | 26 | 18 |
| | 10 | mol % | 51 | 41 | 46 | 46 | 30 | 21 |
| | 40 | mol % | 39 | 33 | 43 | 37 | 25 | 15 |
| Example 3 | 0.1 | mol % | 46 | 37 | 44 | 42 | 24 | 17 |
| | 0.5 | mol % | 47 | 40 | 43 | 40 | 26 | 19 |
| | 1 | mol % | 49 | 40 | 42 | 42 | 32 | 22 |
| | 10 | mol % | 49 | 40 | 48 | 39 | 33 | 21 |
| | 40 | mol % | 43 | 36 | 39 | 35 | 24 | 15 |

TABLE 3
Rubber coverage test

| | | | | Aged rubber coverage | | | | |
|---|---|---|---|---|---|---|---|---|
| | | | | | Room | | High | |
| | | | | | temperature | | temperature | |
| | | | | | and high | | and high | Saline |
| | | | Initial | over- | humidity | Heat | humidity | water |
| | | | rubber | Vulcan- | deteriora- | deteriora- | deteriora- | deteriora- |
| Examples | | | coverage | ization | tion | tion | tion | tion |
| Comp. | Un- | | 95 | 83 | 88 | 85 | 25 | 30 |
| Example | treated | | | | | | | |
| Example 1 | 0.1 | mol % | 100 | 90 | 97 | 100 | 43 | 32 |
| | 1 | mol % | 100 | 96 | 100 | 100 | 60 | 40 |
| | 10 | mol % | 100 | 99 | 100 | 100 | 46 | 43 |
| | 40 | mol % | 99 | 88 | 90 | 99 | 41 | 33 |
| Example 2 | 0.1 | mol % | 100 | 93 | 96 | 100 | 38 | 45 |
| | 1 | mol % | 100 | 95 | 100 | 100 | 48 | 50 |
| | 10 | mol % | 100 | 95 | 100 | 100 | 52 | 51 |
| | 40 | mol % | 95 | 90 | 100 | 100 | 44 | 47 |
| Example 3 | 0.1 | mol % | 100 | 89 | 93 | 100 | 36 | 47 |
| | 1 | mol % | 100 | 90 | 100 | 100 | 43 | 53 |
| | 10 | mol % | 100 | 88 | 100 | 100 | 45 | 58 |
| | 40 | mol % | 98 | 85 | 92 | 100 | 52 | 52 |

※ Aging condition
1) Over-vulcanization: vulcanized at 177° C. for 120 min.
2) Room temperature and high humidity deterioration: left unvulcanized mold under conditions of 31° C. and 90% RH for 15 days, and then vulcanized at 177° C. for 12 min.
3) Heat deterioration: left at 105° C. for 15 days

TABLE 4
Surface corrosion test

| | comp. Example | | | | | | | |
|---|---|---|---|---|---|---|---|---|
| | (untreated) | | Example 1 | | Example 2 | | Example 3 | |
| | Discolor- | | Discolor- | | Discolor- | | Discolor- | |
| Time | ation | Rust | tion | Rust | ation | Rust | ation | Rust |
| 1 hour | X | X | X | X | X | X | X | X |
| 2 hours | X | X | X | X | X | X | X | X |
| 6 hours | ◯ | X | X | X | X | X | X | X |
| 12 hours | ◯ | X | X | X | X | X | X | X |
| 24 hours | ◯ | X | X | X | X | X | X | X |
| 48 hours | ◯ | X | X | X | X | X | X | X |
| 72 hours | ◯ | ◯ | X | X | X | X | X | X |

Discoloration or rust observed: ◯
No discoloration or rust observed: X

From these results, it can be seen that 2-amino-4,6-dimethoxy pyrimidine, 3,5-dimethoxybenzoic acid and m-anisic acid at concentrations of 0.5 mol % showed highest adhesion and rubber coverage, and the treated specimens showed superior adhesion and rubber coverage to untreated specimen. In addition, it was confirmed in the surface corrosion test that the treated specimens prevented the occurrence of discoloration and rust on the surface of the steel cord.

As described above, the tire steel cord according to the present invention has excellent initial and aged adhesion to rubber, improved rubber coverage and controlled oxidation rate on its surface.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A tire steel cord which is produced by coating the surface of a brass-plated steel cord with a compound selected from the group consisting of 2-amino-4,6-dimethoxy pyrimidine, 3,5-dimethoxybenzoic acid and m-anisic acid.

2. The tire steel cord as set forth in claim 1, the compound is dissolved in one and more solvents selected from the group consisting of alcohol, ether, acetone, benzene and water to obtain a solution of 0.1˜40 mol %, and the brass-plated steel cord is dipped into the solution for 0.1˜60 seconds and then dried.

3. A tire using the tire steel cord as set forth in claim 1 as a reinforcing element of tire.
